(19) United States
(12) Patent Application Publication
(10) Pub. No.: US 2006/0114120 A1
(43) Pub. Date: Jun. 1, 2006

(54) System and method for the unpredictable remote control of devices

(76) Inventor: Marc Bennett Goldstone, Bullhead City, AZ (US)

Correspondence Address: Marc Bennett Goldstone, 4090 Yucca Street, Bullhead City, AZ, 86429, US

(21) Appl. No.: 11/264,542

(22) Filed: Oct. 31, 2005

Related U.S. Application Data
(60) Provisional application No. 60/625,315, filed on Nov. 4, 2004.

(51) Int. Cl. G05B 19/02

(52) U.S. Cl. 340/825.72; 340/825.22

(57) ABSTRACT

A device, means, and method for the unpredictable remote control of at least one remote device is provided. A device may include a transmitter, an aperiodic timer, and a command sequence generator to the generated command sequence as controls signal in response to a timer signal from the aperiodic timer or a trigger signal. A method is also provided, which includes the Steps of generating an aperiodic timing signal, generating or retrieving a command sequence in response the aperiodic timing signal or a trigger signal and transmitting the command sequence. The Steps for learning a command, and self-testing the device, and generating the trigger signal based on a sound pattern detected by a sound detector are also described.

### CROSS-REFERENCE TO RELATED APPLICATIONS

The present Utility patent application claims priority benefit of the provisional application for patent number 60/625,315 filed on Nov. 4, 2004 under 35 U.S.C. 119(e).

### FIELD OF THE INVENTION

The present invention relates generally to learning remote controls devices. More particularly, the invention relates to learning remote controls devices, which transmit one or more learned command sequence(s) at pseudo-random time intervals.

### BACKGROUND OF THE INVENTION

Many well known remote control technologies are commonly used in the remote control of devices, especially consumer electronics, for example. Typically, remote controls use a relatively low cost, short distance communications means such as infrared light (IR) or high frequency radio (RF) waves. For infra red communications a carrier frequency (typically in the range of 20 KHz to 60 KHz) is used to permit the infra red reciever (e.g., in a television set) to selectively amplify the incoming IR data without amplifying low frequency (ex. 60 Hz noise from light bulbs) background noise. The infra red transmitters typically use pulse width modulation (PWM) of light emitting diode (LED) drivers to pulse high currents into IR LED's. Most conventional learning remote controls (those which can be taught new codes typically by the end user of the device) include a phototransistor or positive-intrinsic-negative (PIN) photodiode as a sensor to detect IR data from a master remote control, a set-top box, or other device. Some convenitionial learning remotes, with the addition of more complex circuitry, are able to share a single IR LED as both an input and output device.

In response to a remote control button being pressed by a user, conventional remote controls transmit a burst of modulated data (e.g., PWM for IR, or frequency shift keying (FSK) for RF) that corresponds to the button pressed. The remote control signal receiver associated with the device to be controled receives this modulated data, and decodes it to affect a corresponding device action or cause a state change. Otherwise, conventional battery powered remote controls are in a “stand-by” mode (ultra low power consumption) waiting for a button to be pressed by the user, as they are designed for the dedicated purpose of controlling devices (e.g., changing channels on a TV) under the manual control of a user (e.g., the act of pushing a button or, for voice or sound activated remote controls which can recognize specific words such as Channel-UP) and in response issue an IR or RF command to affect the desired change of state in the receiving equipment. Some more sophisticated conventional remote control units are known to have the capability of automatically transmitting a data sequence (i.e., a command) at a specific time of day; such as, for example, in an alarm clock application the remote control is capable of turning on the TV at 6:00 AM to wake up the user. However, known remote controls are not designed for or capable of sending a stored command at unpredictable or unexpected times, which may sometimes be desirable, by way of example, for entertainment or security purposes.

In view of the foregoing, there is a need for additional techniques of implementing remote controls. In particular, it would be desirable if remote controls were capable of sending a stored command at unpredictable or unexpected intervals (e.g., random or pseudo-random) in useful ways.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary schematic diagram of an embodiment of the present invention based on a low cost PIC12F683 micro-controller;

FIG. 2 illustrates an exemplary carrier waveform of a typical infrared (IR) input to the micro-controller on General Purpose port, in accordance with an embodiment of the present invention;

FIG. 3 illustrates a typical IR data sequence input to the micro-controller on a first general purpose port (GP1) by a receiving phototransistor with another port driven by the inverted output of the comparator used to detect the IR data, in accordance with an embodiment of the present invention;

FIG. 4 illustrates a system block diagram of the embodiment shown in FIG. 1;

FIGS. 5 a, b, and c illustrate an exemplary flowchart of a command learning mode, in accordance with an embodiment of the present invention;

FIG. 6 illustrates an exemplary flowchart of the steps for measuring the carrier period of the detected command transmission carrier signal, in accordance with an embodiment of the present invention;

FIG. 7 illustrates a flowchart of exemplary steps for Step of implementing hysteresis on the command transmission detector, in accordance with an embodiment of the present invention;

FIG. 8 illustrates a flowchart of exemplary steps for measuring the rising and falling edge times of bit cells associated with a learned command, in accordance with an embodiment of the present invention;

FIG. 9 illustrates a flowchart of exemplary steps for counting and outputting the number of carrier cycles, in accordance with an embodiment of the present invention;

FIGS. 10a-e illustrate a flowchart of the steps for self-testing, in accordance with an embodiment of the present invention; and

FIG. 11 illustrates a flowchart of exemplary steps for generating a trigger signal based on a sound pattern detected by a sound detector, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of techniques for the unpredictable remote controlling of at least one remote device are described.

In one embodiment of the present invention, a device is provided which includes a transmitter (e.g., an Infrared (IR), ultrasonic, and radio remote control transmitter) operable for transmitting controls signals suitable for remotely controlling at least one function of the at least one remote device, an aperiodic timer (e.g., random, pseudo-random, unpredictable, and chaotic time intervals), and a command sequence generator that is transmitted by the transmitter being configured to the generated command sequence as controls signal in response to a timer signal from the aperiodic timer or a trigger signal.

Some embodiments further include an Infrared (IR) remote control transmission detector and a command learning module operable for learning a command at least in part based on data detected by the transmission detector.

Yet other embodiments further include a sound detector; and a trigger generation module, which generates the trigger signal at least in part based on a sound pattern detected by the sound detector.

In one embodiment of the present invention, the unpredictable remote control of at least one remote device is achieved by way of means for transmitting controls signals suitable for remotely controlling at least one function of the at least one remote device,

means for generating an aperiodic timing signal, and means for generating a command sequence, the transmitting means being configured to transmit the generated command sequence as controls signal in response the aperiodic timing signal or a trigger signal. In other embodiment, means are also provided for learning a command at least in part based on data detected by a means for detecting a command transmission, and/or for self-testing the device, and/or for generating the trigger signal at least in part based on a sound pattern detected by a sound detector.

In yet another embodiment of the present invention, a method for the unpredictable remote controlling of at least one remote device is provided, which includes the Steps of generating an aperiodic timing signal, generating or retrieving a command sequence in response the aperiodic timing signal or a trigger signal and transmitting the command sequence. Some embodiment further include the Steps of learning a command at least in part based on data detected by a command transmission detector, and storing the command data in a memory storage device; and/or the Step of measuring the carrier period of the detected command transmission carrier signal; and/or the Step of implementing hysteresis on the command transmission detector; and/or the Step of measuring the rising and falling edge times of bit cells associated with the learned command, and in which the Step of generating the aperiodic timing signal is at least in part based on the rising and/or falling edge times of a learned command; and/or Steps for self-testing the device; and/or the Step of generating the trigger signal based on a sound pattern detected by a sound detector.

Other features, advantages, and object of the present invention will become mole apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

A first embodiment of the present invention is described below, for the sake of clarity, in terms of a TV set implementation; however, it is to be understood that similar implementations are contemplated for any remote controlled entertainment system component including, but not limited to, a DVD, CD, DVR, Cable/Satellite receiver, VCR, Home Automation System, Computer with a Wireless keyboard, Computer with a wireless mouse or even a remote controlled appliance. One aspect of the present embodiment provides a means for ending the monopoly present in living rooms across the country wherein one TV viewer (often referred to as either a “couch potato” or “remote hog”) latches onto the remote control making all viewing decisions for the family TV and constantly flipping through channels during commercials or multiplexing between a primary and secondary program. The present embodiment at relatively unpredictable or unexpected times (e.g., without limitations random, pseudo-random, chaotic, or aperiodic time intervals) sends a pre-learned (or pre-stored) command(s) to the TV interfering with the TV viewing. The result is that the TV viewer has to scramble for the TV's remote control and figure out which button(s) to push to restore the desired program/operating mode. Following several episodes of interference with the TV this device empowers the person who programs and hides said remote control device described herein to retake control of the Television or stereo from the ‘couch potato’. Once the viewing habits of the ‘couch potato’ have been altered as desired, the device may be disabled and placed elsewhere to cure another remote hog.

The present embodiment may be productized as a practical joke ‘Gag’ gift that inteferes with a television or other remote controlled consumer electronic device or appliance by transmitting a stored command(s) at random or pseudo-random intervals to intefere with the normal use of the entertainment equipment. This permits interference with TV viewing even though the person who placed the unit may be long gone.

Some applications of the present embodiment may be used to annoy or torment the ‘couch potato’ by causing seemingly random ‘Glitches’ in their entertainment equipment, and eventually causes the remote control ‘Hog’ to either relinquish control to their companion or find something else to do, rather than be tormented for all practical purposes indefinitely. Being hidden, the device is designed with low power modes to assure at least a two month battery life.

In a preferred embodiment, the batteries can be changed and the stored IR data is retained in non-volatile momory. Upon a power on reset, (as batteries are installed) the firmware makes a determination of whether or not a valid IR sequence is stored in non-volitile memory. If a valid IR sequence is found the firmware continues with transmissions based on triggers from the pseudo-random/random timer. If no valid IR sequence is stored the firmware enters sleep mode until the push-button (PB) is depressed, which interrupts the micro-controller, exits sleep mode and continues code execution. If the PB is depressed for >3 seconds the firmware (FW) enters learn mode to capture an IR sequence or ‘Macro’ of several sequential commands for subsequent retransmission. In light of the teachings of the present invention, those skilled in the art will readily recognize how to configure the necessary hardware, fireware, and/or software to achieve the foregoing functionality.

In another aspect of the present invention, the unpredictable or unexpected command transmission aspect of the present invention is directed towards home security embodiments wherein the user may) use the present invention to control (e.g., turn on, turn off, change volume, etc.) a remote controllable device (e.g., a TV, stereo, etc.) to thereby simulate the home being actively occupied while, for example, no one is home or everyone is sleeping. Conventional consumer appliances either have no programmable timer(s) to turn them on and off though a few have ‘Alarm Clock’ functionality to turn them on or off at specified times. Such timers are easy for would be criminals to surmise that no one is actually home when they observe a repeatable timer pattern of consumer device activity (e.g., TV/stereo activity). In this way, the present embodiment makes an unpredictable pattern of consumer device activity to simulate actual use, and thereby take advantage of the deterrent effect that perceived activity in the home has to would be criminals that might otherwise assume the home will be easy to break in to.

In another aspect of the present invention, the unpredictable or unexpected command transmission aspect of the present invention is directed towards IR or RF remote controlled home automation systems wherein the user may use the present invention to control the home automation system. The home automation system in response to the unpredictable or unexpected command transmission simulates the home being occupied while, for example, no one is home or everyone is sleeping. Conventional home automation systems only have programmable timer(s) to turn various lights or appliances on and off at specified times, or within a few minutes of specified times. Such timers make it easy for would be criminals to surmise that no one is actually home when they observe a repeatable timer controlled pattern of consumer device activity (e.g., porch light on at 8:00 PM and off at 11:00 PM, +/−10 minutes or so). In this way, the present embodiment makes an unpredictable pattern of consumer device activity to simulate actual use, and thereby take advantage of the deterrent effect that perceived activity in the home has to would be criminals that might otherwise assume the home is unoccupied.

In yet another embodiment of the present invention, the unpredictable or unexpected command transmission aspect of the present invention is directed towards computers that have wireless keyboards and/or pointing devices (mice). The present embodiment interferes with keyboard/mouse data to control the computer receiving said wireless commands. In practice, the user would see extra keystrokes, or sudden mouse movements from time to time and would need to make periodic deletions or corrections to the document being edited at the time of the interference.

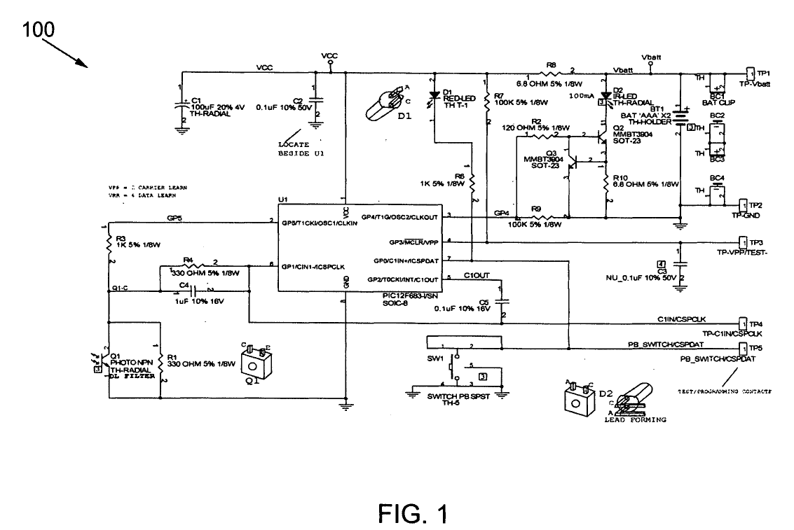

FIG. 1 illustrates an exemplary schematic diagram of an embodiment of the present invention based on a low cost PIC12F683 micro-controller. Those skilled in the art will recognize a multiplicity of alternate and suitable hardware implementations to carry out the described aspects of the present invention.

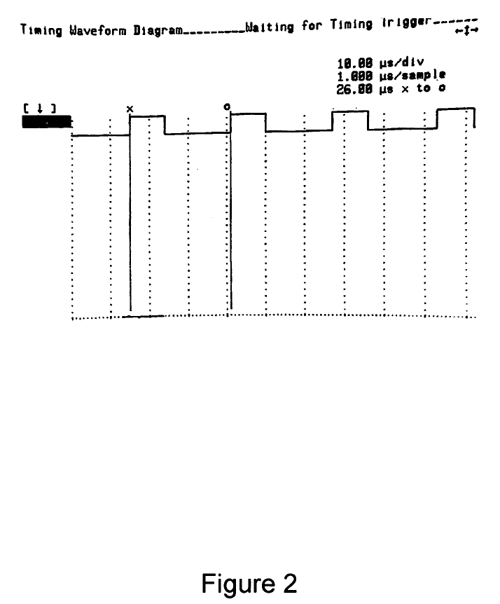

FIG. 2 illustrates an exemplary carrier waveform of a typical infrared (IR) input to the micro-controller on a General Purpose port#1 (GP1) by a receiving phototransistor with a General Purpose port #2 (GP2) tri-stated, in accordance with an embodiment of the present invention. The carrier frequency shown by way of example has a period of 26 μs, or 38.5 kHz.

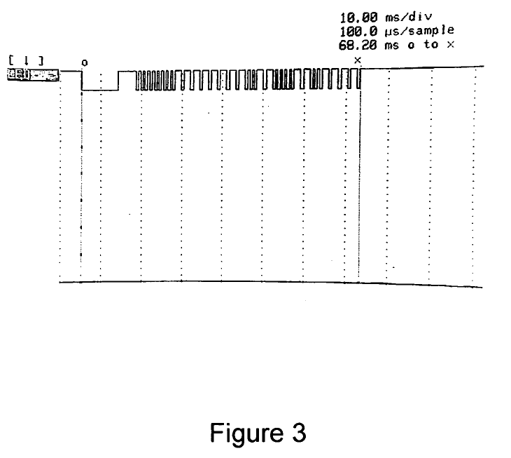

FIG. 3 illustrates a typical IR data sequence input to the micro-controller on GP1 by a receiving phototransistor with port GP2 driven by the inverted output of the comparator used to detect the IR data, in accordance with an embodiment of the present invention. This data is later used to key the carrier waveform output on a General Purpose port #4 (GP4).

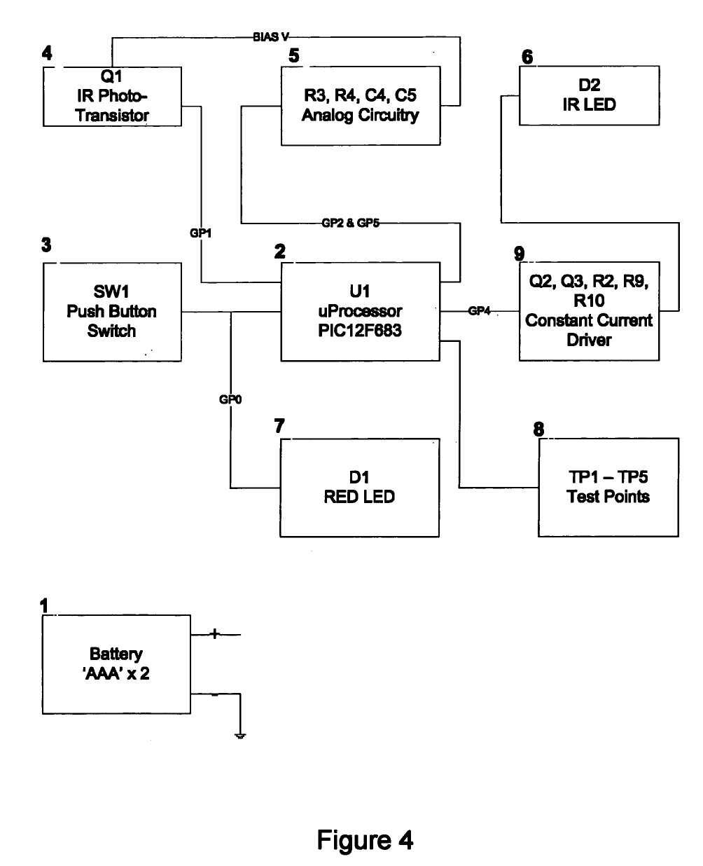

FIG. 4 illustrates a system block diagram of the embodiment shown in FIG. 1.

A preferred embodiment of the present invention, herein referred to as the first embodiment, has firmware running in a battery powered PIC12F683 micro-controller U1 shown in FIG. 1.

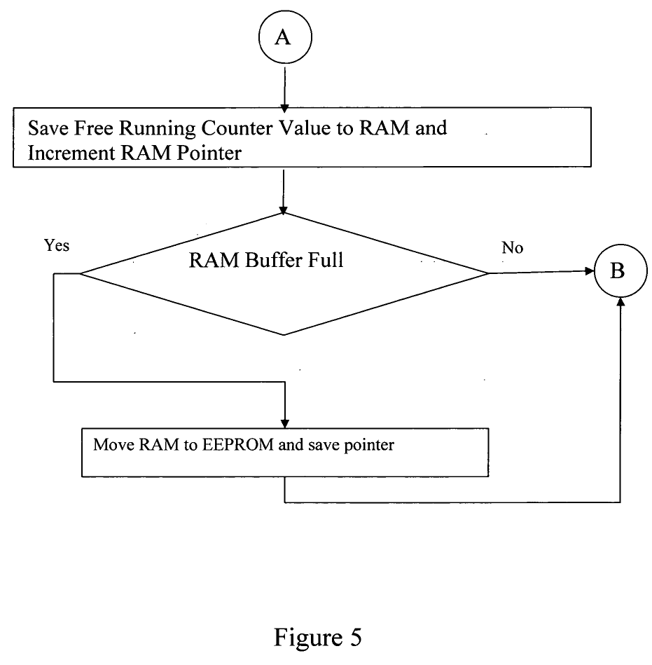

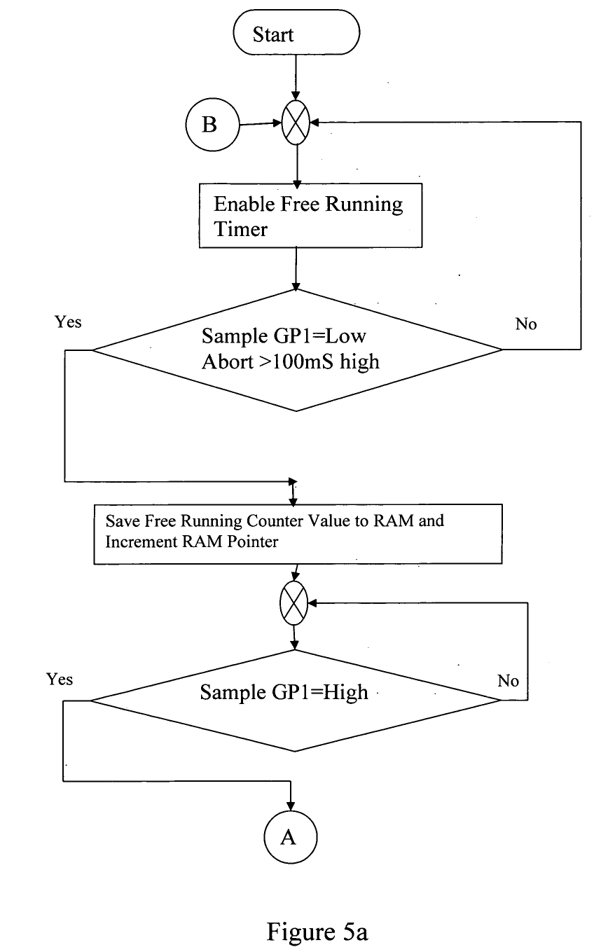

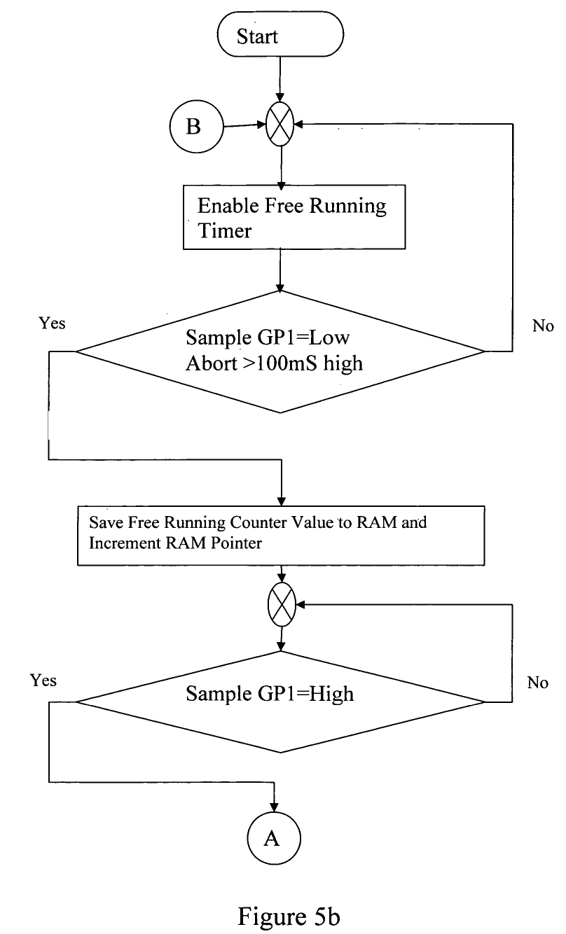

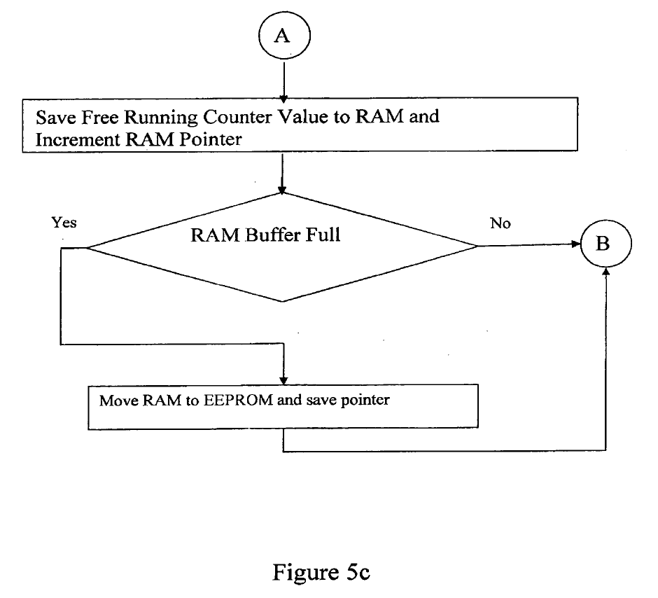

FIGS. 5 a, b, and c illustrate an exemplary flowchart of a command learning mode, in accordance with an embodiment of the present invention. While in Learn mode, the firmware facilitates measurement of both the carrier frequency (an example of which is shown in FIG. 2) and the actual data (an example of which is shown in FIG. 3) produced by the TV or other entertainment equipment (master) IR remote controller. A relatively low cost daylight filtered NPN Infra Red (IR) phototransistor Q1 can be chosen as the sensor. The daylight filter prevents ambient visible light from skewing the bias point of the input device. PIN photo diodes suffice as a sensor though their cost is considerably more due to their larger silicon area and the need for an amplifier, preset band pass filter to match a specific carrier frequency and an AGC circuit. The standard PIN photodiode receiver modules such as the Sharp GP1U271R do not permit measurement of the carrier frequency used by the TV's remote control as only the low frequency data stream is output from these modules. This limitation would have otherwise precluded the successful measuring of the carrier frequency, which is helpful for maximizing the operational range of the First embodiment. Maximized operational range between the First embodiment and the TV is achieved in the preferred embodiment of this invention by closely matching the TV remote's carrier frequency, which presumably matches the band-pass of the TV's IR receiver. It is the TV's IR receiver band pass filter that causes undesirable attenuation of the received IR signal if the carrier frequency is not optimized. The result of this attenuation manifests itself as reduced operational range between the First embodiment and the TV set, an undesirable characteristic. To facilitate a relatively lower cost solution, due to current memory limitations with the low cost micro-controller U1 selected, the First embodiment preferably learns only one IR command, although alternate embodiments of the invention are provided with the ability to learn a multiplicity of different commands. Yet other embodiments can group several commands together and treat them as a ‘Macro’ that is all transmitted in a single transmission. The random time interval triggered transmission of a particular command, in the multiple command case, randomly or sequentially alternates between the learned commands. An aspect of this approach in “TV Hog” applications is that the TV remote Hog has to figure out which of several TV remote buttons is needed to restore viewing, taking more time and, thereby, causing more frustration.

In the preferred embodiment of this invention, with reference to FIG. 1 and FIG. 4, there are several operational modes each controlled by firmware and described in the following:

A learn mode will next be discussed in some detail, in accordance with an embodiment of the present invention. During the learning (i.e., programming) phase, the user initiates one or more contiguous data transmissions from the master remote controller. The present embodiment is applicable to a wide range of master remote control units. In the following description, it is assumed the master remote is a handheld television remote control, but a master remote control unit for a stereo system or other consumer electronic device, etc., may just as easily be appreciated.

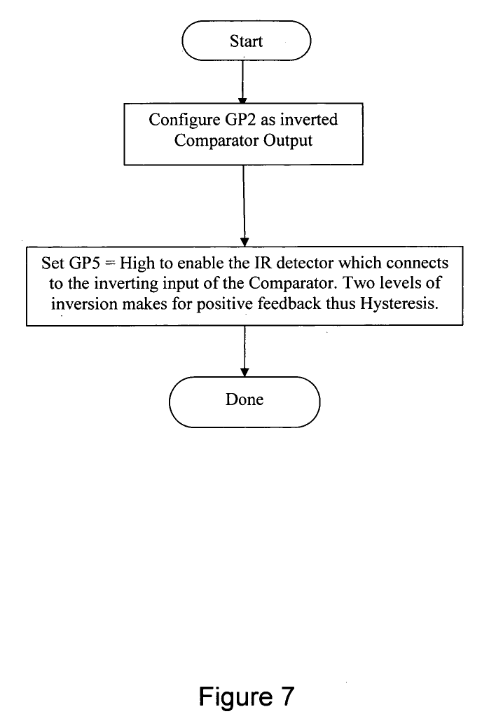

In the context of the first embodiment, and in continuing reference to FIG. 1 and FIG. 4, learn mode is invoked by the user holding a push-button switch PB SW1 depressed (contacts closed) for more than 3 seconds. When the contacts of PB SW1105 first close a micro-controller U1U1 pin General Purpose port #0 (GP0) goes low waking the micro-controller U1U1 from low power sleep mode. The firmware validates >3 seconds of GP0 low and then initializes various I/O ports as described in the following: Firmware reconfigures GP0 as an output with a low level to maintain the illumination of a LED D1 (e.g., a red LED), which is ON during the closure of PB SW1, to provide visual status to the user indicating that the First embodiment has entered learn mode. Firmware reconfigures a General Purpose port#5 (GP5), previously set to be an output at a low level, now as a high logic ‘1’ output level. This high level on GP5 and a Resistor R3 acts as a pull-up to the collector of photo-transistor Q1. Q1 is configured in a common emitter configuration with its collector connected to General Purpose port#1 (GP1), an input on the micro-controller U1U1 by a resistor R4, and a capacitor C4. Firmware, upon entry into Learn mode configures a GP1 as the non-inverting input of its internal comparator. The other input (effectively the inverting input) of the comparator is driven by an internal programmable voltage reference set to low range and VRR=3 yielding approximately a 0.375V threshold for carrier measurement. The internally inverted comparator output (swaps the inverting and non-inverting inputs of the internal comparator as shown in the micro-controller's data sheet) is selectively routed to micro-controller pin General Purpose port#2 (GP2), which is configured as either an input (high impedance) or as the inverted comparator output. During carrier measurement, GP2 is configured as an input and the comparator acts as a simple voltage threshold detector. During data learn when configured as the comparator output, GP2 provides AC feedback (hysteresis) through capacitor C5 effectively differentiating the input signal present on GP1. FIG. 7 illustrates an exemplary flowchart of the steps for Step of implementing hysteresis on the command transmission detector, in accordance with an embodiment of the present invention. This is helpful in the recovery of the data sequence as it eliminates the high frequency carrier. During data learn mode the VRR threshold is set to VRR=5 for a comparator threshold of approximately 0.625V.

Learn mode in the present embodiment has two aspects, the first to measure the carrier frequency and the second to record the actual data sequence from the master TV remote control. The order of these two measurements is not important. The following implementation example arbitrarily measures the carrier first followed by the data sequence.

To measure the carrier frequency transmitted by the master TV remote control (typically in the range of 20 KHz to 58.8 KHz) the firmware configures GP0 as an output and sets it to a high logic ‘0’ level. This sinks current through RED LED D1 to signify to the user that the unit 100 has entered Learn Mode. The firmware configures GP5 as an output ‘1’ level. Resistor R3 acts as a pull-up to the collector of Photo-transistor Q1 that is used in a common emitter configuration. GP2 is tri-stated and GP1 is configured as an analog input to the internal comparator of micro-controller U1U1. When configured in this way, Q1 will produce a low ‘0’ output pulse corresponding to the master TV remote control's LED ON periods within each carrier cycle.

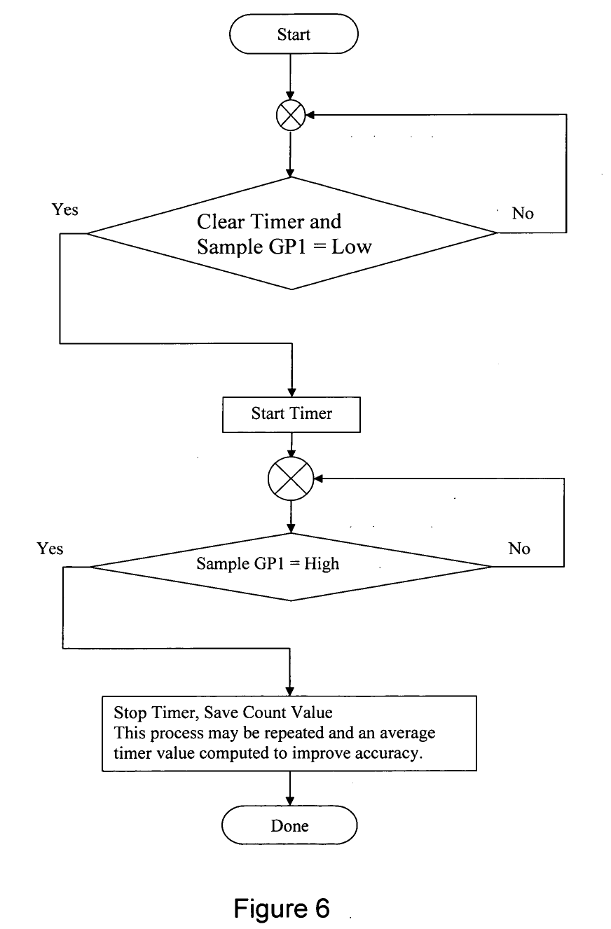

FIG. 6 illustrates an exemplary flowchart of the steps for measuring the carrier period of the detected command transmission carrier signal, in accordance with an embodiment of the present invention. Firmware measures the period of several carrier cycles and qualifies the measurement based on several near identical measured periods. The firmware then saves this period for later use in transmitting the learned data sequence. If no carrier period within the capture range (20 KHz to 58.8 KHz) can be measured the firmware defaults to a 26 uS period. This allows for some TV remote codes that do not use a carrier. The 26 uS period as tested functions correctly with these TV's.

To record the data the firmware enters a data capture phase in which lower frequency measurements are desired, the photo-transistor Q1 is again used as the sensor this time with GP2 outputting the inverted comparator's output. GP2 and associated capacitor C5 configures the Comparator circuit for AC feedback (hysteresis) helpful in recovery of the data sequence. The comparator circuit now differentiates the input signal present on GP1. This is helpful in recovery of the data sequence as it eliminates the high frequency carrier. During data learn mode the VRR threshold is set to VRR=5 for a comparator threshold of approximately 0.625V.

Firmware initializes an internal timer then waits for a start bit before recording timer values for each transition as seen on the Comparator's output. The timer values are first stored in fast random access memory (RAM) and if the RAM buffer gets full firmware parses the data stream into segments, momentarily stops the recording of additional data, copies the timer values acquired from RAM to electrically erasable programmable read-only memory (EEPROM), and then resynchronizes to the start bit of the next transmission from the master TV remote control, picking up the recording of timer values where it had left off capturing each subsequent transition. All the timer data corresponding to positive and negative transitions of the data are stored in the EEPROM. This process will be repeated until either the EEPROM buffer area is full or until an inter command gap of >100 mS is detected. Since with the low cost PIC12F683 micro-controller U1U1 a single byte write to EEPROM can take as long as 6 mS, Firmware requires several transmissions by the master TV remote control to record and save a lengthy command sequence. The EEPROM contents are non-volatile, permitting the user to change or remove batteries without losing the learned command sequence.

In a preferred embodiment, a transmit mode of a valid stored command is invoked by two means. The first is in response to the user quickly depressing (<3 seconds) and releasing the PB SW1. The second is by firmware in response to a Watch Dog Timer (WDT) wakeup from low power sleep mode if said firmware qualifies this particular wakeup from sleep event as occurring at or beyond the current random time interval.

During transmit mode the firmware sequentially outputs serial data with transitions occurring when a free running timer matches the recorded timer count previously stored in EEPROM on output pin GP4. A high level on GP4 turns ON a IR LED D2, and a low level turns IR LED D2 OFF. A resistor R9 biases a transistor Q2 off during the power-on-reset interval and until GP4 is initialized as a low level output ‘0’ port. NPN transistor Q2, driven by GP4 through resistor R2, is configured as an emitter follower. When the voltage across current sense resistor R10 reaches ˜0.7V NPN transistor Q3 turns on, effectively reducing the base drive to Q2. This circuit acts to limit the current through Infra Red LED D2. In the preferred embodiment, a current of approximately 100 mA is chosen to provide sufficient long range transmission capability over a wide operational voltage range of 2.1 V through 3.6V that can be expected from a pair of alkaline cells. Firmware precludes leaving GP4 high for more than approximately ½ of the carrier frequency's period as previously measured in the carrier learn mode. The ˜50% duty cycle limits power dissipated in Q2 and D2 to a safe value.

A random interval timer will next be discussed in some detail, in accordance with an embodiment of the present invention. This function controls when the unit 100 transmits the stored IR command sequence.

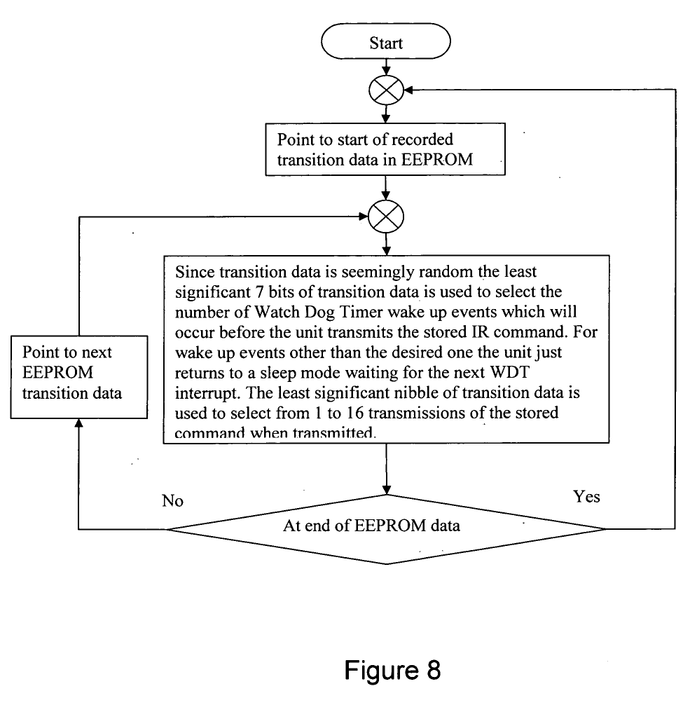

FIG. 8 illustrates an exemplary flowchart of the steps for measuring the rising and falling edge times of bit cells associated with a learned command, in accordance with an embodiment of the present invention. In the preferred embodiment the random interval timer is provided by a firmware routine, which uses the least significant byte (LSB) of the EEPROM data corresponding to rising and/or falling edges of the previously learned IR command since the LSB has the most variability. The EEPROM data is generated by firmware that records the free running timer (clocked at 1 MHz) count when the comparator qualifies the positive and negative transitions of the master TV remote's asynchronous data. The subtle timing differences from transition to transition and particular timing for a given master TV remote command assure a pseudo-random number. This random number is used as a count of WDT wake up events before the micro-controller U1 transmits the stored command data. Firmware returns to a low power sleep mode as soon as a given wake up event is determined not to be the one matching the wake up count. The WDT is clocked by an un-calibrated ˜31 KHz clock source that is followed by a prescaler within the micro-controller. The uncalibrated clock frequency results in further randomization of the time delays. The prescaler count is selected to provide the minimum and maximum delay between the WDT induced wake up events within a range such that the minimum interval is in the several minute range and the maximum interval is in the range of several hours.

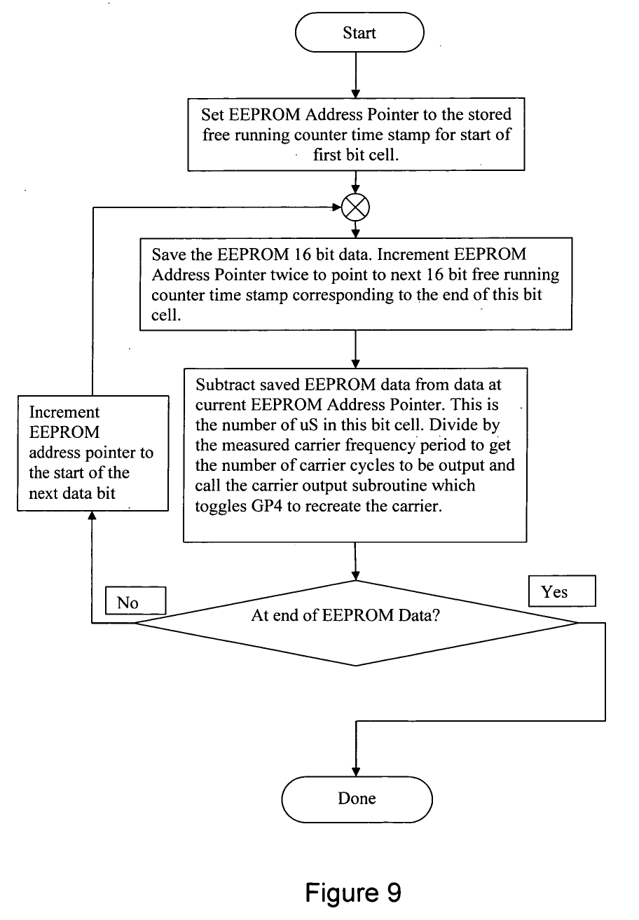

FIG. 9 illustrates an exemplary flowchart of the steps for counting and outputting the number of carrier cycles, in accordance with an embodiment of the present invention. As shown in the flowchart, the firmware counts the number of carrier cycles that occur between the start and end of each bit cell of the command data, and, when transmitting a bit cell of a command sequence, the number of transmission carrier cycles corresponding to the counted number is outputted.

Other means for providing a random time delay interval or otherwise unpredictable behavior are well known in the art, some of which are contemplated as alternative implementations.

One such possible implementation is a lineal random number generator that by example is limited to the range of 1 through 127. This range, in conjunction with the internal un-calibrated 31 KHz oscillator within the micro-controller clocking the WDT with the largest prescaler value available (2¹⁶), a count of zero gives an ˜4.5 minute delay while a count of 127 gives a 9.5 hour delay.

In another implementation, rather than computing each random interval a pseudo-random data table with bounded values (in this example bounded by 1-127) is stored in nonvolatile memory. The table entries create a seemingly random interval though repetition occurs when the last table entry is reached and the sequence is restarted at the first table entry. Since with a reasonable pseudo-random table length and an average period of 4 hours and 45 minutes (9.5 hours/2) between transmissions the repeating sequence is imperceptible. In both the computational or table driven approaches, reducing the prescaler at firmware compile time from 2¹⁶ to 2¹⁴ reduces the interval to a range between 1.125 minutes and 2.375 hours, which has the effect of more frequent interference with the TV. As before, the random trigger mechanism is still used. The mean time between transmissions is then (2.375*60−1.125)/2 or about 70 minutes.

In the preferred embodiment the two least significant bits of the low byte of timer transition data is used by firmware to control the number of identical command sequences which are to be output. The effect is that the remote control Hog has to figure out how to restore his TV program by requiring a different number of button pushes on his TV remote. If the stored command is the channel-up button, by way of example, this feature sometimes increments the channel by 1, 2 or 3 channels. The Hog has to press the channel-down button on his remote a corresponding number of times.

An embodiment of a Low Power Sleep Mode will now be discussed in some detail with reference to FIG. 1. To reduce power consumption the micro-controller U1U1 goes to sleep immediately after enabling the WDT. When the WDT times out it resets the micro-controller U1, the internal calibrated 4 MHz oscillator starts and ˜256 uS later after an oscillator startup delay the micro-controller U1 begins execution at the reset vector. Since in normal operation there are only two means for waking the micro-controller U1 from sleep mode, firmware based on status flags determines whether the WDT had timed out or whether the user had pressed the PB SW1. Though the WDT awakens the micro-controller in the preferred embodiment at 1.125 minute intervals, only when the random delay interval (desired number of WDT cycles) is reached does an IR transmission take place. If the random/pseudo-random time interval has not yet been reached then the firmware clears the WDT and causes the micro-controller U1 to reenter a low power sleep mode for the next 1.125 minutes. The short operational duty cycle where a transmission is not desired serves to reduce power consumption.

An embodiment of a Production Test Mode will now be discussed in some detail with continued reference to FIG. 1. Test point contacts J1-1 through J1-5, which are pads on the PCB that make contact via spring probes within a test fixture. These signals are typically used for in-circuit programming. There are two test modes, the first to program/reprogram firmware into the FLASH memory of micro-controller U1 and the second a system test of the hardware and firmware. In this mode, the batteries are not installed.

Connection can be made via spring probes in a dedicated fixture between the tester's internal electronics and the Unit Under Test (UUT). In this way, material cost to the end product is minimized as only test pads are required and not a physical connector. A card edge interface can also be utilized if the UUT's PCB FAB has chamfered edges, although the inclusion of chamfered edges adds significant cost to the printed circuit board (PCB)'s fabrication.

An embodiment of a Hardware Tester will now be discussed in some detail with continued reference to FIG. 1. The internal tester electronics in one embodiment is a customized Microchip PICKIT1 development board with In Circuit Programming (ICSP) capability that is powered by the USB port on a personal computer (PC). A fiber optic cable, Lexan light pipe or mirror(s) built into the test fixture routes IR light emitted by IR-LED D2 to Photo-transistor Q1 permitting a self test. The software for programming the FLASH is the PICKIT v1.4 code compatible with the PIC12F683 micro-controller U1. The PICKIT1 invokes program mode by powering off TP1, and driving TP3, TP4 and TP5 low. The tester then drives TP3 (VPP/TEST-) pin to the programming voltage between 9V and +13.5V followed by 4.5V to 5.5V on TP1 (Vbatt) and finally driving TP4/GP1 (CSPCLK) and TP5/GP0 (CSPDAT) with clock and serial data respectively. During this test, the data and clock logic levels are 4V minimum for logic one and 1V maximum for logic 0. The PICKIT1 FW verifies that the FLASH and EEPROM memory matches the program just loaded. Following programming the VPP/TEST-signal is driven low then high to reset the micro-controller U1.

An exemplary Test Procedure will next be discussed in some detail with continued reference to FIG. 1. Before each programming session, the operator must verify that the ‘code protect’ box in the tools menu remains checked. The operator then types ctrl+I to load the object code (.HEX firmware file) and upon receipt of ctrl+W the firmware is written into FLASH memory. With in a few seconds the tester resets the UUT. On exiting reset, the firmware just programmed into the UUT is executed. Custom electronics on the PICKIT1 board prototype area pulse GP3 (VPP/TEST-) low approximately 10 mS after exiting reset to allow the micro-controller U1 to initialize the I/O ports, setting GP3 as an input, and disabling its ability to generate any further resets. A low on GP0 (button press) while GP3 is low invokes the special production test firmware.

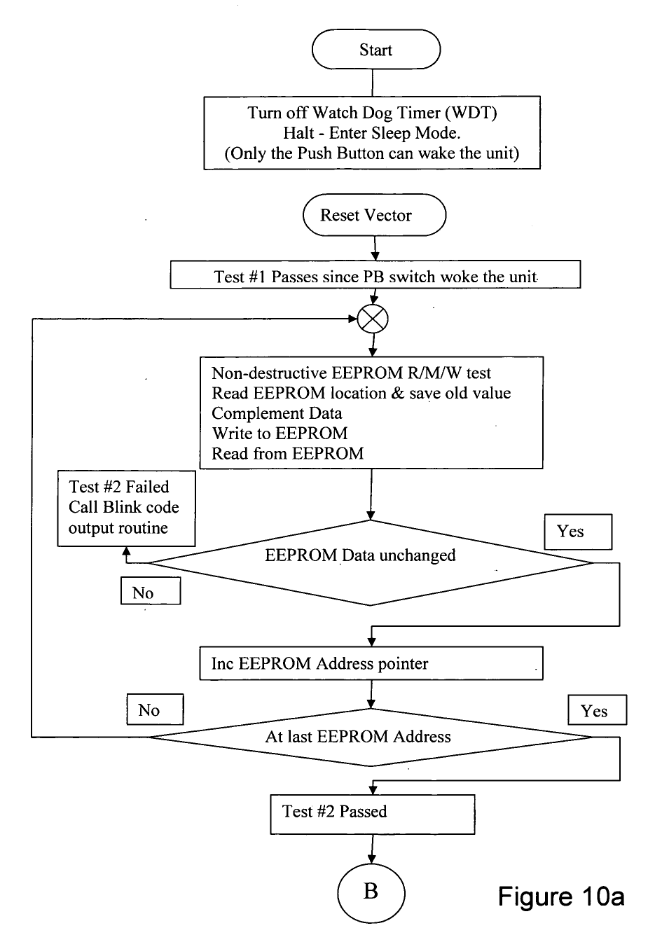

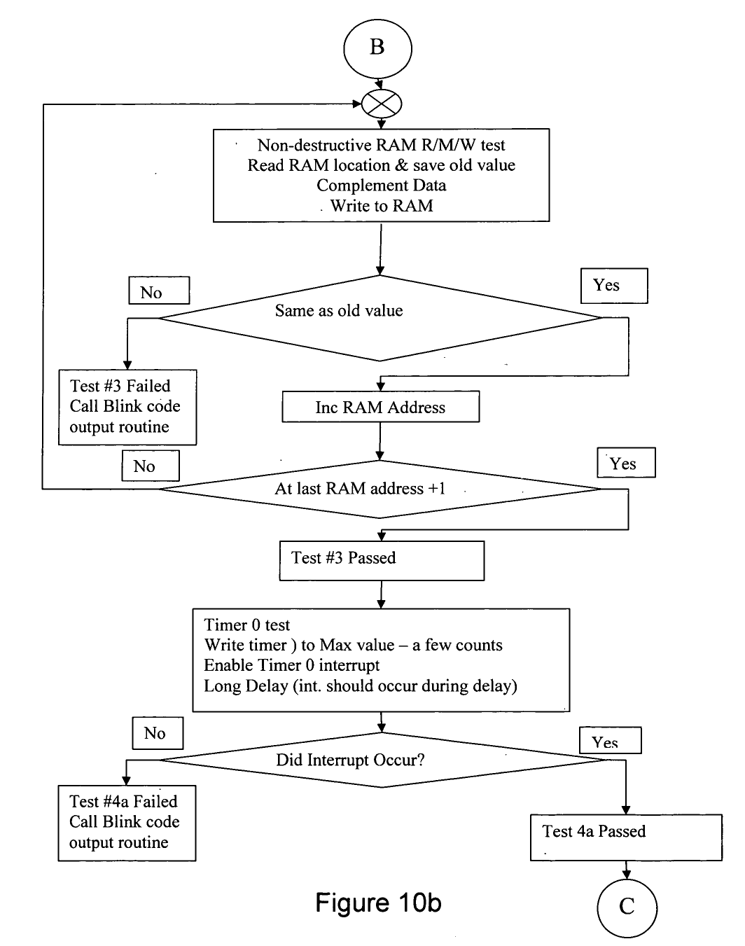

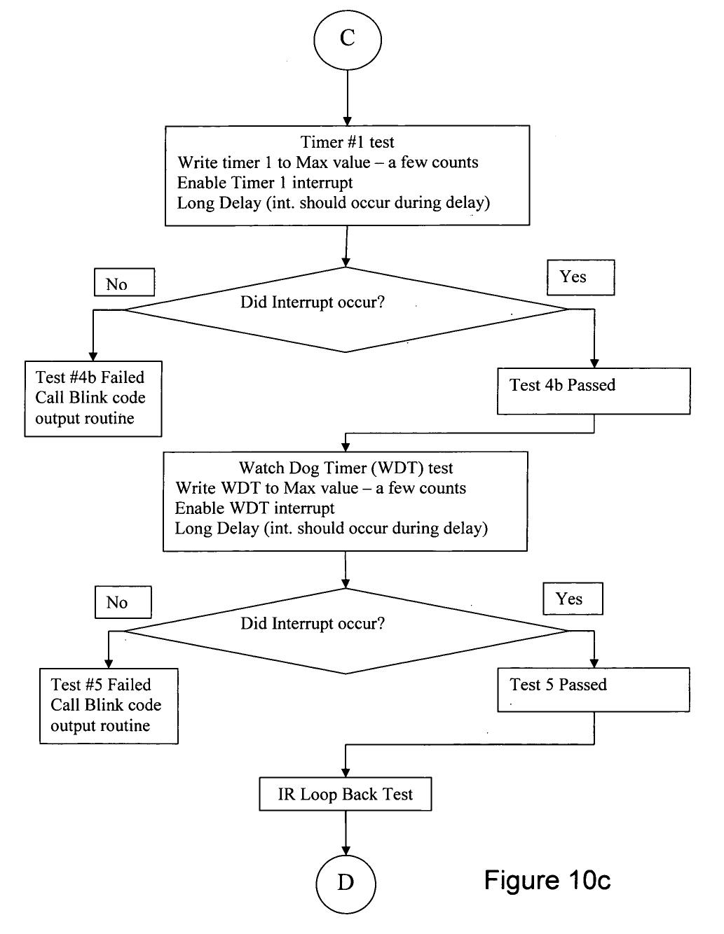

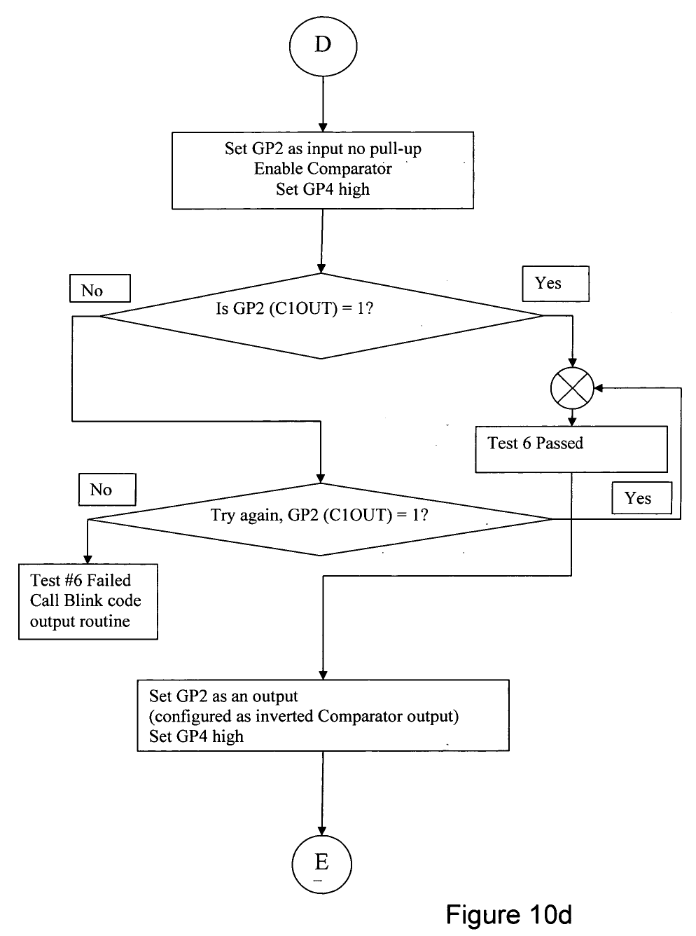

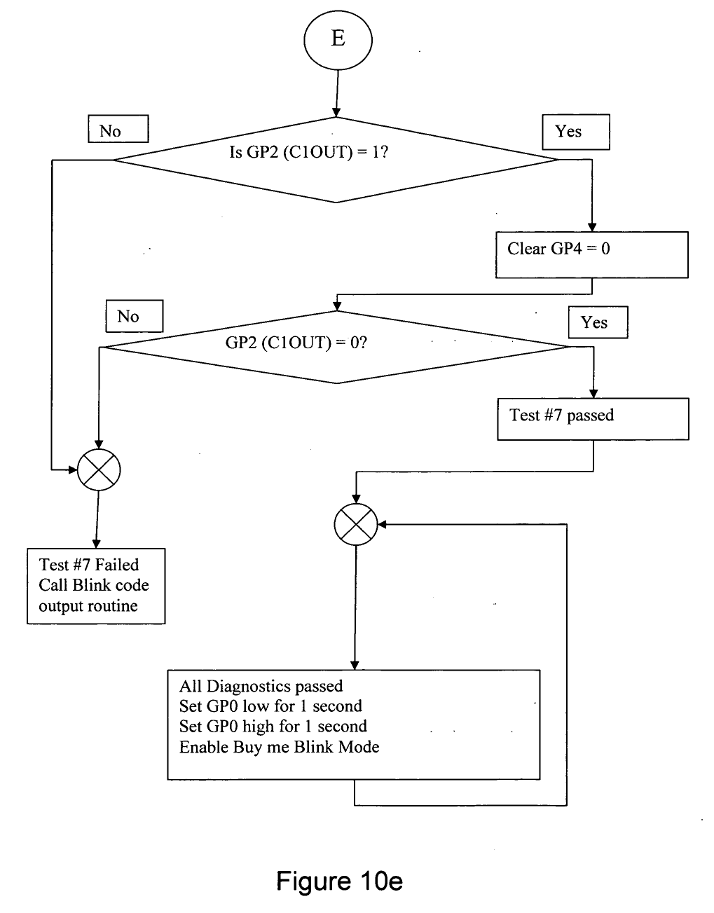

FIGS. 10a-e illustrate an exemplary flowchart of the steps for self-testing, in accordance with an embodiment of the present invention. In the preferred embodiment, a production test firmware is included along with the operational firmware within the FLASH memory. An exemplary test procedure proceeds as follows:
1) Tests that PB SW1 wakes micro-controller U1 from sleep mode;
2) Tests EEPROM (nondestructive);
3) Tests RAM (nondestructive);
4) Tests Timers;
5) Tests that WDT wakes micro-controller U1 from sleep mode;
6) Sets the I/O ports and comparator for carrier frequency detection (GP2 as input, no pull-up) and turn on D2. Poll C1OUT several times looking for a high level. If not high then shows a fail status. Now turns off D2 and polls C1OUT several times for a low level. If not low, signifies a fail status;
7) Sets up the I/O ports for data stream recording (GP2 as inverted C1OUT) and turns on D2. Polls GP2 for a high level. Turns off D2 and polls GP2 looking for a low level;
8) Upon Pass blinks RED LED at 1 second on/1 second off, indefinitely;
9) Upon Fail blinks RED LED with the blink code indefinitely corresponding to the failing test number 1-7 as described above.

One or more transmissions by the master remote are required in the preferred embodiment of this invention to measure the carrier frequency (period) and one or more additional transmissions are required when this device records the data sequence. Besides the photo-transistor there is another input device to the micro-controller U1, this being a single momentary contact pushbutton switch PB SW1 that is used to enter the learn mode as well as to manually cause the transmission of the stored IR data at the measured carrier frequency. This manual transmission capability is needed for verifying that the learned code sequence functions identically to the corresponding master TV remote control's function key. PB SW1 is also used to initiate a transmission to enable verification that the unit 100 where hidden has sufficient range to control the TV. After de-bouncing the PB SW1 input, the firmware determines which mode was desired by measuring the length of the PB SW1 depression. A momentary depression <3 seconds causes the stored IR sequence to be transmitted. A depression >3 seconds invokes program mode.

In the preferred embodiment and for lowest manufacturing cost and since the device spends nearly all of its useful lifetime hidden from view there is no need for the typical injection molded packageing so common in consumer electronic devices. Since the highest voltage present is 3.6V there is no shock hazard. The battery holder BT1 is a desirable choice since it minimizes the potential for shorting the two cells inadvertainly. The device is provided with a hook & loop fastener that has adhesive used for attachment to the solder side of the PCBA, which prevents shorting of the battery holder solder connections should it be placed on a conductive surface. The adhesive also provides for attachment to a mounting surface while hidden in the TV viewing room.

To help reduce cost, all regulatory agency approval numbers and place of manufacture are preferably affixed to the PCB by text in etch, silkscreen, or a label. The unit 100 has the following major devices: battery(s) BT1; micro-controller U1 containing Firmware; (3), push buttom switch PB SW1; (4), IR photo-transistor; (5), phototransistor bias circuit R3 and R1; (6), and IR LED; (7), visible red LED for displaying status during programming, (8), Test Points TP1 through TP5 for in circuit programming of the micro-controller U1.

An exemplary method of carrier frequency measurement will next be discussed in accordance with an embodiment of the present invention. The firmware controlled learn mode operates as follows: First, the user is instructed to hold the TV's remote in contact and alignment with the photo-transistor of unit 100 while depressing and holding depressed, the desired button on the master TV remote control. While continuing to press the master TV remote's button the user slides the master TV remote away from the unit 100 at approximately 0.25 inch/second until the visible LED ‘FAST’ blinks signifying that the master TV remote is within an acceptable range. As distance increases the IR illuminating the photo-transistor decreases in intensity. This permits the comparitor to detect the low amplitude carrier signal with a simple and low cost threshold detector.

Next the user continues to slide the master TV remote away from the unit 100. Several more fast blinks are seen followed by two slow blinks when the carrier period is acquired. Rather than two blinks, the firmware slow blinks the RED LED three times if it cannot measure and qualify a carrier frequency. The firmware then defaults to a middle of the road 26 uS period carrier. This is done since a few master TV remotes don't use carrier pulses. These TV's accept the 38.4 KHz carrier and operate successfully. The user releases the master TV remote's button.

An exemplary method of command data sequence learning will next be discussed in accordance with an embodiment of the present invention. In the present embodiments the FW instructs the micro-controller to enable the inverted comparitor output onto GP2. The user now presses and releases the master TV remote's button several times until the RED LED fast blinks four times to signify that the data has been recorded.

The preferred embodiment records the timing of the rising and falling transitions as seen in FIG. 3. Note that when the remote control's IR LED is ON the waveform in FIG. 3 is low.

Due to the slow <6 mS byte write timing speed of the EEPROM and the limited amount of fast access time RAM (128 bytes) in the micro-controller U1 chosen, the FW parses the data stream into two or more consective blocks requiring several depressions of the master TV remote's PB. When the last data block is captured and recorded to the EEPROM the visible RED LED slow blinks four times. In accordance with an embodiment of the present invention, a transmit (XMIT) mode works as follows.

FW takes ⅓ to ½ of the carrier's period and turns ON IR LED for this duration, that is, if the time is within the recorded IR LED-ON sequence. More specifically, FW turns on the IR LED if the ON time of the IR LED for this ½ bit cell is 100% within the captured data's IR LED ON period. 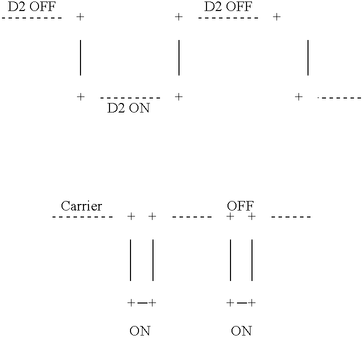
Recorded IR LED D2 ON sequence stored in EEPROM

In this case FW outputs two ½ carrier periods of IR LED D2 ON. In another embodiment, a Pulse Width Modulation (PWM) IR LED driver circuit may be used to pulse higher currents using energy stored in an inductor to drive the IR LED D2 one or more times during each carrier ON time pulse shown in the sketch above to maximize the distance between the the remote control unit of the present embodiment and in this case the TV set. The incremental cost of the PWM controller, whether internal to a micro-controller or implemented with external circuitry, is not desirable in this application.

The user tests the recorded command by momentarily pushing the button (<3 second duration) on the present remote control while aiming D2 at the TV. If the IR data sequence (in this example a channel up command) was recorded correctly, the channel increments. The firmware briefly blinks the red LED as an indicator thaty the command has been output. Note the visible RED LED only blinks when outputing the command following a manual button push.

The user then hides the the remote control of the present embodiment and retests (by briefly pushing button SW1) its ability to reach the TV from the hiding spot. If the TV doesn't respond the user adjusts the position of the the remote control unit of the present embodiment and retests its ability to communicate.

One possible cost cutting or more convenient to use embodiment of the present invention stores hundreds of the most common IR command sequences and either outputs them all one after the other serially when the random/pseudo-random interval has elapsed. Because of the amount of data transmitted this would significantly reduce the battery life. In addition, outputting so many codes increases the likelihood that one of the codes causes undesired operation of an IR device for which the transmission was not intended.

Another possible cost cutting measure, in accordance with another embodiment of the present invention, is to have a multiple key keyboard so that the customer can enter a code corresponding to the manufacturer and model number of the equipment to be controlled, eliminating the need for the carrier and data learn modes and their extra complexity. However, the read only memory (ROM) requirement is greater if hundreds of unique codes are to be stored. In addition, in some applications, programming is more complicated if after selecting the manufacturer and model number the actual button or function (such as channel up) needs to be selected. In some applications, the addition of a multi key keyboard, more ROM and higher pin count micro-controller device may not be cost effective, and the larger size of the unit would make it more difficult to hide from view.

Rather than a micro-controller U1, some embodiments of the present invention implement the basic functionality with a state machine and sufficient memory. The complexity of the state machine and non-volatile memory make it a more costly alternative. There are digital voice recorders built into pens, for example, that can be modified to record IR sequences rather than the sounds picked up by a microphone. Similarly, such a device outputs data through an IR LED rather than a speaker. To function in this application these devices need a random/pseudo-random interval timer function and thus are contemplated as within the scope of the present invention.

In some embodiments of the present invention, following production testing of the unit 100 a ‘retail package blink enable (RTBE) bit’ is set in EEPROM and if the product is destined for retail sales (e.g., those sold directly to stores) batteries are installed before the unit 100 is placed into the retail packaging. PB SW1 switch is configured to permanently clear the ‘RPBE’ bit and due diligence is taken to not push the PB SW1, except by the consumer. When this bit is set a timer prescaler that causes blinks at given rate (e.g., one per minute) is selected, or the blinking rate may be configured to be at randomized time intervals. Rather than transmitting IR data, only the visible Red LED is fast blinked and then goes back to sleep for another minute. As soon as the end user opens the clam-shell package and presses the PB SW1 switch for the first time the RTBE bit is permanently cleared and the product operates without the attention catching blinking since a visible blinking light makes the unit 100 easy to detect while hidden in a dark room.

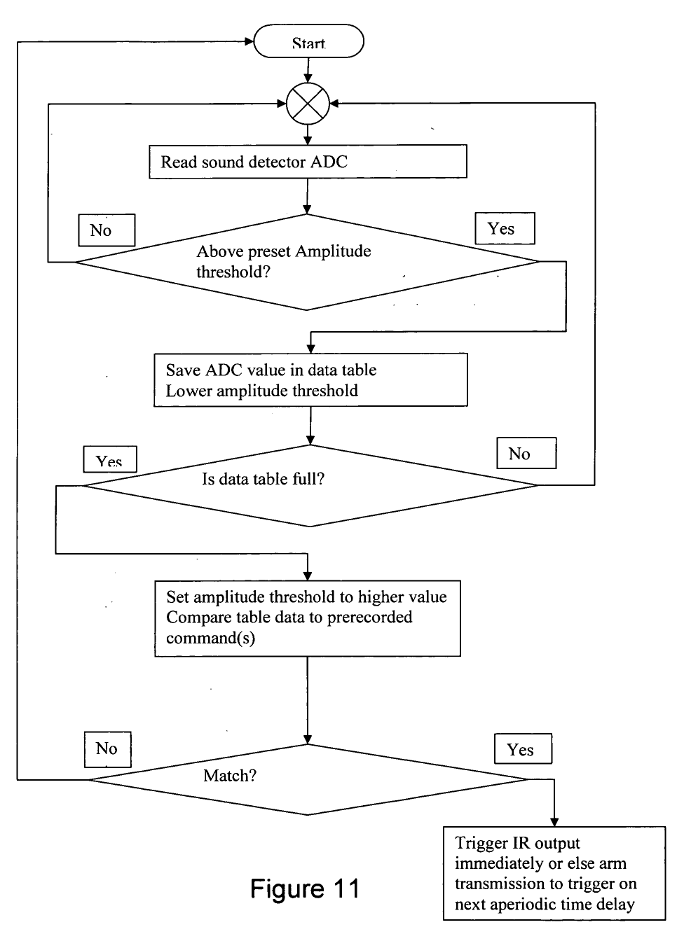

FIG. 11 illustrates a flowchart of exemplary steps for generating a trigger signal based on a sound pattern detected by a sound detector, in accordance with an alternate embodiment of the present invention. In the instant embodiment of the present invention, a sound level triggered remote control unit is configured with hardware and software (e.g., the steps shown in the Figure) to be capable of turning DOWN the volume of a TV or Stereo system following detection of sound levels in excess of a preset or adjustable threshold. A contemplated application is one used by parents to keep their kids' music down to a tolerable level. To do this, the device is hidden in the child's room. Following a delay (predictable or unpredictable), a sampling window is opened in which sound level is sampled and, if above the threshold, causes the transmission of stored IR command(s) at unpredictable times after the sound is determined as exceeding a preset or adjustable threshold. The unpredictable delays make early detection of the hidden device unlikely. To conserve batteries the unit 100 has either low power analog circuitry to wake the micro-controller U1 up from sleep mode in response to an excessive noise level or, in a preferred embodiment, the micro-controller U1 periodically wakes up at regular or irregular periods, then samples the sound level, compares the amplitude with a pre-set threshold (set by a manual sensitivity control), and then goes back to sleep unless the sound exceeds the threshold, in which case it causes the transmission of the stored IR command sequence. If the unit 100 is AC powered this is not a concern, however having a cord or wire plugged into an AC receptacle makes detection of the unit 100 more likely. If an excessive sound level is detected the device transmits one or more stored IR or RF command sequences to turn down the volume. The data that is transmitted to the TV, stereo or other remote controlled noise making device can be one or more learned commands or a table of permanently stored commands that are capable of turning down the volume of many of the most popular sound making consumer electronic devices such as stereo's, TV's, etc. The present embodiment effectively implements a closed loop volume limiting control system with either an IR or RF means for communicating the correction information to the TV, Stereo system or other remote controlled device that is sourcing, the noise.

Some applications of the threshold based, delayed command transmitter embodiment includes applications where it may be desirable to affect a closed loop volume control system, such as limiting the volume of a teenager's stereo system not to exceed a threshold set by a parent. In this application example, the unpredictable aspect would make it difficult for the teenager to notice a gradual reduction in volume.

In some sound triggered embodiments of the present invention, the trigger may be generated based on frequency patterns instead of amplitude thresholds. By way of example, and not limitation, a, software and/or hardware, filter (e.g., bandpass, band reject, high/low pass, notch, etc.) may be implemented to trigger on sounds within or outside a specified band, to, for example, trigger on human speech or music. In yet other sound triggered embodiments, a combination of time domain and frequency domain based filtering may be implemented according to known pattern recognition techniques to trigger on only certain types of sounds. Those skilled in the art will readily recognize how to implement a multiplicity of frequency and/or amplitude based triggering schemes in accordance with the teachings of the present invention.

Typical users of the present invention are contemplated to include husbands, wives and children of all ages. Conceivably there can be enclosures suitable for hiding a device with the functionality described herein in plain sight. By way of example, and not limitations the unit 100 can be disguised within a book, fake TV remote control or other item which is commonly found in the living room of a typical home.

In yet another embodiment of the present invention, instead of transmitting a stored or learned command at relatively unpredictable times, the command codes are automatically generated according to an algorithm suitable for constructing viable command codes. Designing such a command building algorithm is well within the skill of those skilled in the art. For example, without limitation, the command set for some consumer devices may have a certain range of on/off sequence codes and/or a certain time between sending each bit in the code, and an algorithm could be create to sweep through the range of likely valid codes and/or timings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, firmware, microcode and the like.

Having fully described at least one embodiment of the present invention, other equivalent or alternative methods of implementing unpredictable remote controls according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A device for the unpredictable remote control of at least one remote device, the device comprising:
a transmitter operable for transmitting controls signals suitable for remotely controlling at least one function of the at least one remote device;
an aperiodic tinier; and
a command sequence generator, the transmitter being configured to transmit the generated command sequence as controls signal in response to a timer signal from said aperiodic timer or a trigger signal.

2. The device according to claim 1, wherein said aperiodic timer generates the timer signal at random, pseudo-random, or chaotic time intervals.

3. The device according to claim 1, wherein said aperiodic timer is generates the timer signal at substantially unpredictable time intervals.

4. The device according to claim 1, wherein the device is a portable device.

5. The device according to claim 1, further comprising an Infrared (IR) remote control transmission detector.

6. The device according to claim 5, further comprising a command learning module operable for learning a command at least in part based on data detected by the transmission detector.

7. The device according to claim 1, wherein said transmitter is an Infrared (IR) remote control transmitter and the device further comprises a test fixture configured to feedback the IR emitter output of said IR transmitter to said IR detector.

8. The device according to claim 1, further comprising:
a sound detector; and
a trigger generation module, which generates said trigger signal at least in part based on a sound pattern detected by the sound detector.

9. The device according to claim 1, wherein said transmitter is an Infrared (IR) remote control transmitter.

10. A device for the unpredictable remote control of at least one remote device, the device comprising:
means for transmitting controls signals suitable for remotely controlling at least one function of the at least one remote device;
means for generating an aperiodic timing signal; and
means for generating a command sequence, said transmitting means being configured to transmit the generated command sequence as controls signal in response said aperiodic timing signal or a trigger signal.

11. The device according to claim 10, further comprising means for learning a command at least in part based on data detected by a means for detecting a command transmission.

12. The device according to claim 10, further comprising means for self-testing the device.

13. The device according to claim 10, further comprising means for generating said trigger signal at least in part based on a sound pattern detected by a sound detector.

14. A method for the unpredictable remote controlling of at least one remote device, the method comprising the Steps of:
generating an aperiodic timing signal;
generating or retrieving a command sequence in response said aperiodic timing signal or a trigger signal, said command sequence being suitable for remotely controlling at least one function of the at least one remote device; and
transmitting said command sequence.

15. The method according to claim 14, further comprising the Steps of learning a command at least in part based on data detected by a command transmission detector, and storing the command data in a memory storage device.

16. The method according to claim 15, further comprising the Step of measuring the carrier period of the detected command transmission carrier signal.

17. The method according to claim 15, further comprising the Step of implementing hysteresis on the command transmission detector.

18. The method according to claim 15, further comprising the Step of measuring the rising and falling edge times of bit cells associated with the learned command, and in which the Step of generating the aperiodic timing signal is at least in part based on the rising and/or falling edge times of a learned command.

19. The method according to claim 15, further comprising the Steps of counting the number of carrier cycles that occur between the start and end of each bit cell of the command data, and, when transmitting a bit cell of a command sequence, outputting a number of transmission carrier cycles corresponding to the counted number.

20. The method according to claim 10, further comprising Steps for self-testing.

21. The method according to claim 10, further comprising the Step of generating said trigger signal based on a sound pattern detected by a sound detector.
